(19) United States
(12) Patent Application Publication
(10) Pub. No.: US 2005/0066877 A1
(43) Pub. Date: Mar. 31, 2005

(54) Fuel mixture dial

(76) Inventor: Steve Smith, Brighton, MI (US)

Correspondence Address: Michael T. Raggio;Dinnin & Dunn, P.C., Ste. 500, 2701 Cambridge Court, Auburn Hills, MI, 48326, US

(21) Appl. No.: 10/957,368

(22) Filed: Sep. 30, 2004

Related U.S. Application Data
(60) Provisional application No. 60/507,821, filed on Sep. 30, 2003.

(51) Int. Cl. F01L 7/00; G01D 13/12

(52) U.S. Cl. 116/298

(57) ABSTRACT

A fuel mixture dial for use with a fuel container. The fuel mixture dial having a first body member and a second body member adjacent to another. The dial having a third body member adjacent to the second body member. A fastener extending through all body members. The body members all rotate relative to one another.

Continuation of Provisional Application Ser. No. 60/507,821—Filed: Sep. 30, 2003

### TECHNICAL FIELD

The present invention relates generally to dials, gauges and similar indicators, and relates more particularly to an adjustable dial for indicating fuel octane or fuel mixture ratio, particularly for gasoline oil mixtures, and an ornamental design therefore.

### BACKGROUND OF THE INVENTION

Two-stroke engines for recreational motorized devices as well as landscaping and various home maintenance machines have been known and widely used for decades. Relatively smaller engines are used in applications such as string trimmers, chain saws and snow blowers. Relatively larger two-stroke engines are also known, including outboard motors for boats, snowmobile engines, personal watercraft, and similar recreational applications. Such two-stroke engines typically run on a mixture of gasoline and motor oil, the motor oil providing lubrication and cooling of the reciprocating engine pistons. Various factors bear on the proportion of gasoline to oil used, for example, the size of the engine and the intended engine operating speeds.

In many residential homes, residents may store a variety of two-stroke devices and other gasoline engines. The variability in gasoline to oil proportions and different fuel types can necessitate a collection of fuel storage containers, one for each of several devices. This often large collection of fuel containers can lead to significant confusion as to what mixture is present in each container. It is important to provide the manufacturer's recommended fuel mixture for each individual engine. Where a mixture is inadvertently provided that is too rich (more oil in the mixture than is desirable), engine operation can be negatively affected, both in terms of starting ability as well as development of carbon deposits and other fouling of the engine components. Where a mixture is too lean (where the gasoline to oil proportion is too high) the engine may experience insufficient cooling and/or lubrication, creating a significant risk of piston seizure and/or catastrophic failure of the engine. An examination of a typical residential garage can often reveal a disordered collection of fuel containers, many of which may be marked by the owner with indelible ink or taped labels, in an attempt to organize and identify the various fuel mixtures for their respective applications. One drawback to marking the fuel container is that it may thereafter be difficult or impossible to accurately identify the fuel mixture therein, if a different fuel mixture is subsequently used than the one initially stored. Alternatively, users may decide to discard fuel containers when they are no longer needed for a particular fuel mixture, a wasteful and expensive course of action. Further still, users may discard fuel, often in an environmentally hazardous fashion, rather than risk inadvertently placing the wrong mix or fuel type into a machine.

It is thus desirable to provide a simple, adjustable device for identifying a particular fuel mixture in a fuel container, and to provide, an ornamental design for such a device.

### SUMMARY OF THE INVENTION

The present invention provides a fuel mixture dial that preferably comprises a housing having a plurality of pieces, adapted to attach to a fuel container. Each of the plurality of housing pieces is preferably rotatable relative to the other housing pieces. A snap or similar fastener-type attachment is preferably provided and holds the plurality of housing pieces in substantially flush alignment in substantially parallel planes. Each of the housing pieces are preferably substantially circular, and at least one of the housing pieces preferably includes a plurality of mixture ratios written thereon in a radial pattern. At least a second of the plurality of housing pieces preferably includes a cut-out region, allowing a user to read the fuel octane or mixture printed on the first housing piece. In a first embodiment, the fuel mixture dial provides loop means preferably adapted to receive a chain, zip-tie or similar device, for attaching the dial to the fuel container. In a second embodiment, the dial preferably includes a central aperture through each of the flush aligned housing pieces, allowing the dial to be placed over a fuel pour spout. In yet another embodiment, the present invention preferably provides a fuel container cap having a plurality of pieces, rotatable relative to one another to indicate to a user the fuel mixture stored therein. In still another embodiment the dial is directly attached and/or secured to the fuel container by any known fastening technique.

### BRIEF DESCRIPTION OF THE DRAWINGS

FIG. 1 is an illustration of fuel mixture dial and fuel container in accordance with a preferred embodiment of the present invention;

FIG. 2 illustrates a fuel mixture dial and fuel container in accordance with a second preferred embodiment of the present invention;

FIG. 3 illustrates an exploded view of a fuel mixture dial similar to FIG. 1;

FIG. 4 illustrates one piece of a fuel mixture dial according to a preferred embodiment of the present invention, having mixture information marked thereon;

FIG. 5 illustrates a bottom view of a fuel mixture dial according to the present invention;

FIGS. 6 and 7 illustrate side views of a fuel mixture dial according to a preferred embodiment of the present invention;

FIG. 8 illustrates a top view of a fuel mixture dial according to a preferred embodiment of the present invention.

### DETAILED DESCRIPTION

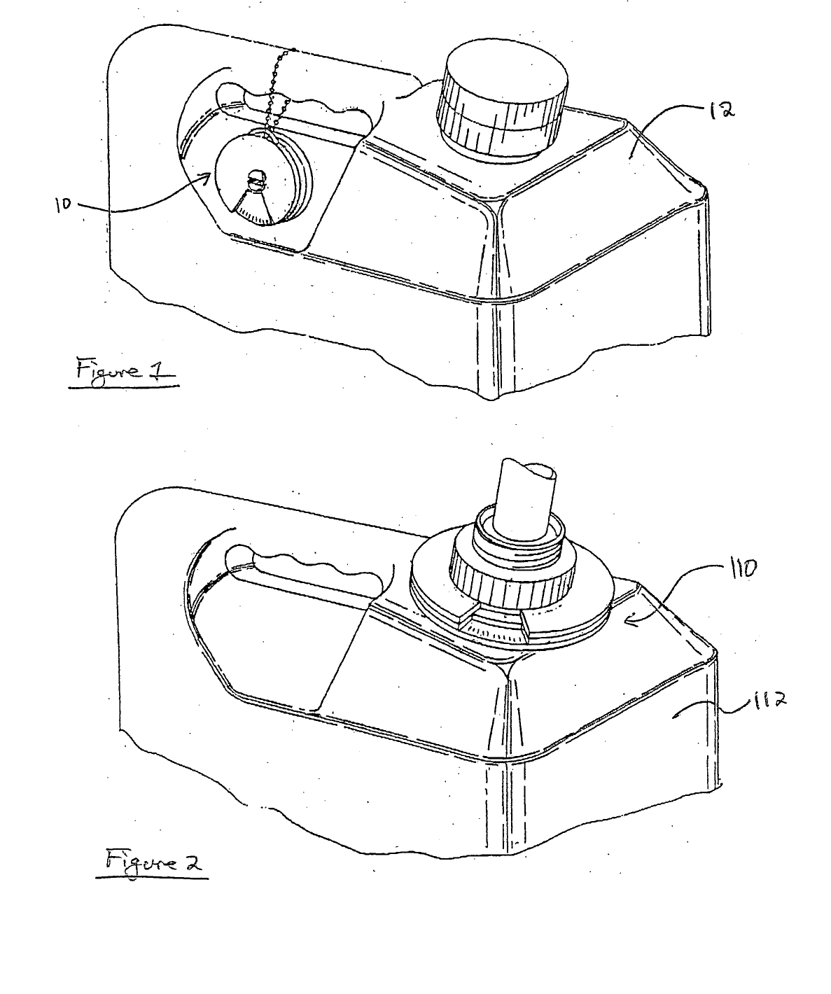

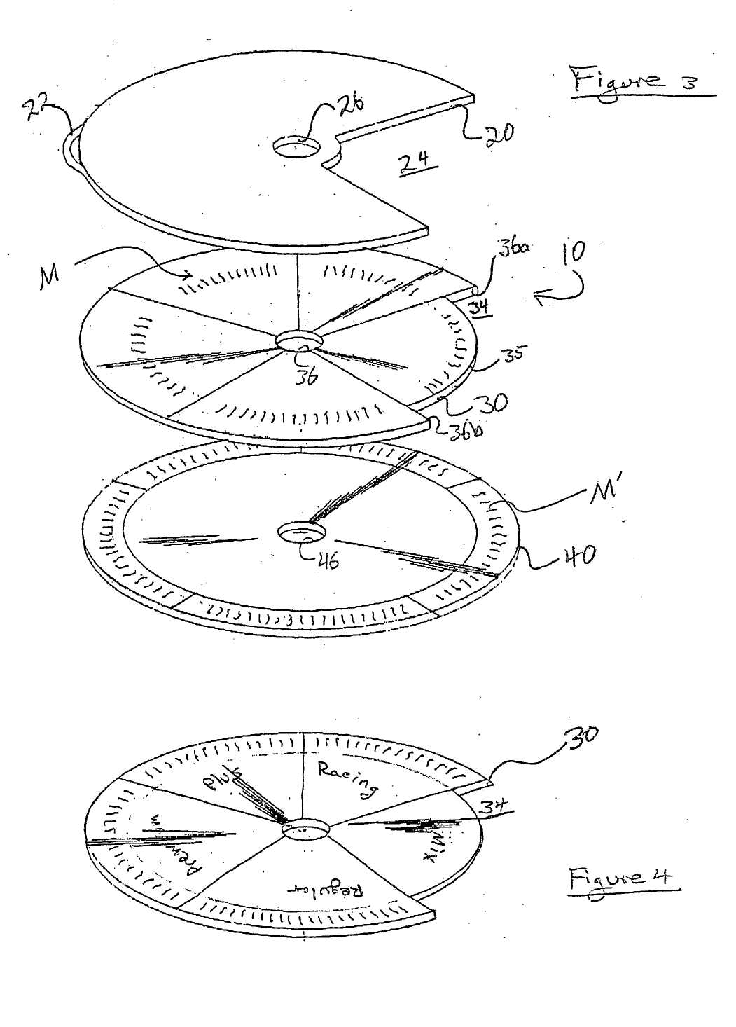

Referring to FIG. 1, there is shown a fuel mixture dial and fuel container in accordance with a preferred embodiment of the present invention. Fuel mixture dial 10 is preferably attached to the handle of a fuel container 12 via a chain, zip-tie, cord or similar device. Referring to FIG. 2, there is shown a second embodiment 110 wherein the fuel mixture dial 110 is positioned about the spout of a fuel container 112. It should also be noted that the fuel mixture dial 10 may also be secured to or integrated with the fuel container 12 by any known or future method. Turning to FIG. 3, there is shown a partial exploded view of a fuel mixture dial 10 similar to the dial of FIG. 1. Fuel mixture dial 10 preferably includes a plurality, for example three, molded plastic body portions 20, 30 and 40. However, any other number of portions may also be used. A first of the body portions 20 is preferably a top portion and is a substantially circular member preferably including a loop 22 extending from a periphery thereof, adapted to engage with a chain, cord, zip-tie or similar device. First body portion 20 is preferably a substantially planar, substantially circular member having a cut-out region 24 and a center aperture 26. In a preferred embodiment, cut-out portion 24 is substantially wedge shaped, however, this design might be departed from without departing from the scope of the present invention. A second or center body portion 30 is also illustrated, and is preferably substantially circular and substantially planar. Second body portion 30 is preferably imprinted or otherwise marked (for example by embossing) with fuel mixture ratios. Exemplary markings are shown schematically, and denoted “M” in FIG. 3. Second body portion 30 also preferably includes a cut-out region 34, that has a preferably substantially arcuate inner edge 35 bounded by linear edges 36a and 36b at opposite termini thereof. In a preferred embodiment, linear edges 36a and 36b are oriented substantially perpendicular to a line tangent to arcuate edge 34 at an intersection there between, however, variations in this design, for example, wherein edges 36a and 36b define obtuse or acute angles relative to arcuate edge 35, or are non-linear are contemplated. A third body portion 40 is also preferably provided, and is preferably substantially planar and substantially circular. Body portion 40 is preferably marked to convey fuel mixture ratio information, preferably written, embossed, etc. around a periphery thereof denoted M′ in FIG. 3. It should be noted that it is contemplated to have a protrusion on a knob extending from the periphery of any of the body portions. The knobs or protrusions may exist in the rotation of any of the body portions with relation to one another. It should also be noted that more than one protrusion or knob may extend from the periphery of any of the body portions. It should also be noted that loop 22 may also be of any other known form such as but not limited to a tab extending from a periphery of any of the body portions with that tab having an orifice therethrough or a plurality of orifices therethrough for connection of a fastening device. The tab may be of any known shape depending on the design requirements and manufacturing needs for the fuel mixture dial.

FIG. 4 illustrates a body portion similar to third body portion 40 of FIG. 3, with fuel information printed thereon. Exemplary markings include the type of fuel, such as premium, plus, regular, racing, as well as fuel and oil mix. By rotating first body portion 20 relative to body portion 30, the different sets of workings can alternately be exposed to view via cut-out 24. Where a user selects “mix,” preferably printed in an area of body portion 30 proximate cut-out 34, mixture ratio markings M′ on body portion 40 can be viewed via cut-out 34. Thus, a user can select any of several different mix ratios printed on body portion 40 by rotating portion 30 relative thereto.

Turning to FIG. 5, there is shown a bottom view of a fuel mixture dial 10 similar to FIG. 1. FIG. 5 illustrates third body portion 40 and a fastener 50 that extends axially through body portions 20, 30, and 40. In a preferred embodiment, fastener 50 is a molded plastic piece having a shape such that body portions 20, 30 and 40 can be fitted thereover, via apertures 26, 36 and 46, but do not pass readily in a reverse direction, thus resisting disassembly of the three body portions when engaged via fastener 50. It should be appreciated, however, that various other means might be employed for holding body portions 20, 30, and 40 in flush, substantially coaxial fashion. For example, a rivet having a first diameter at opposite ends, and a second, smaller diameter between the first and second ends might be utilized to hold the three body portions together. Further still, a bolt and nut or similar fastening device might be employed. It is desirable to employ fastening means that are robust enough that the body portions of dial 10 can be rotated relative to one another, but resistive enough to rotation such that once the respective body portions are positioned to indicate a particular fuel type or fuel mixture, they will not be dislodged from such an orientation inadvertently. Yet another embodiment (not shown) utilizes on axially flexible fastener, allowing the respective body portions to be separated axially, rotated to a new orientation, then re-engaged. Teeth or a suitable high friction surface or coating is positioned about a periphery, and extends inwardly thereof, of each housing piece. Such a surface is preferably located on the sides of each housing member facing another housing member such that the flexible fastener will urge the teeth, high friction surfaces, etc. into facing engagement and thus minimize relative rotation among the housing portions.

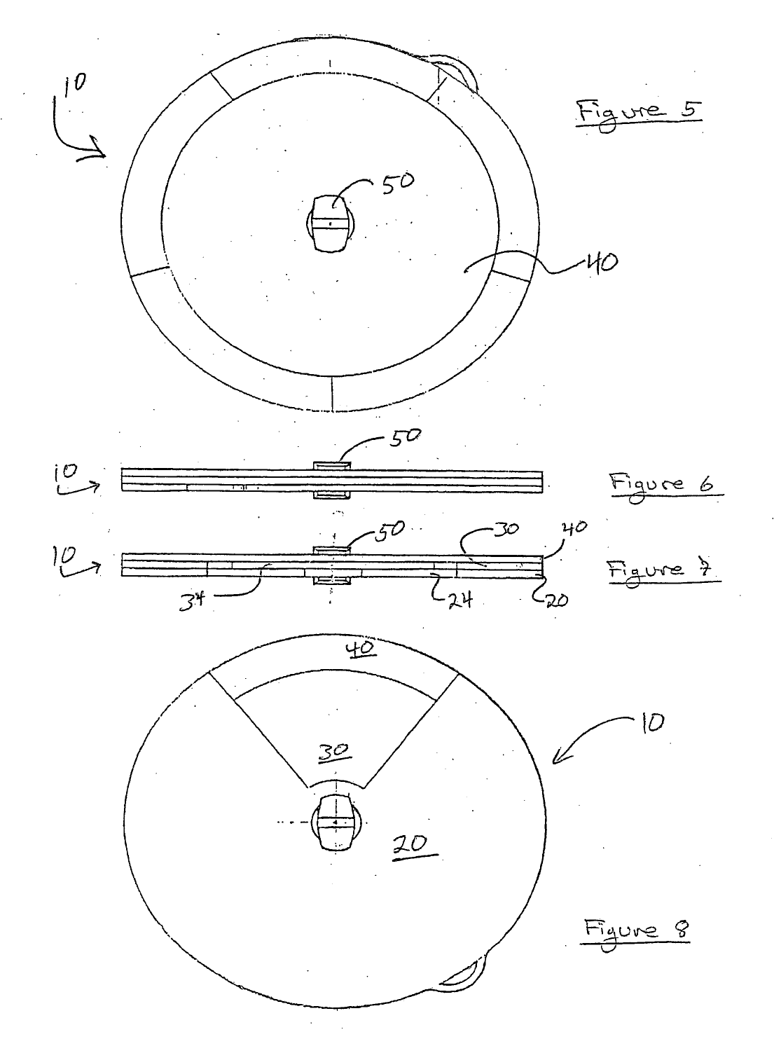

Referring now to FIGS. 6 and 7 there are shown side views of dial 10. FIG. 6 illustrates a side view of dial 10 in its assembled state, taken approximately from a vantage point radially offset from both of cut-outs 24 and 34. Stated another way, FIG. 6 illustrates an exemplary design of dial 10 as it would appear viewed from a position at which cut-outs 24 and 34 are not visible. FIG. 7 illustrates an exemplary view of dial 10 as it would appear looking substantially directly at a center of cut-outs 24 and 34. Thus, as illustrated in FIG. 7, first body portion 20 is positioned at a bottom position, second body portion 30 is at a center position, and third body portion 40 is at a top position, and the three respective body portions are held in substantially flush, substantially parallel positions via fastener 50. Referring now to FIG. 8, there is shown a top view of dial 10, illustrating a top surface of first body portion 20, a top portion of second body portion 30 and a top portion of third body portion 40.

The present description is for illustrative purposes only, and should not be construed to narrow the breadth of the present invention in any way. Thus, those skilled in the art will appreciate that various modifications might be made to the presently disclosed embodiments without departing from the spirit and scope of the invention. Other aspects, features, and advantages will be apparent upon an examination of the attached drawing figures.

1. A fuel mixture dial, said dial including:
a first body member having a notch or cutout portion therein;
a second body member arranged adjacent to said first body member; and
a third body member arranged adjacent to said second body member, said second body member arranged between said first and third body member.

2. The dial of claim 1 wherein said first, second and third body members having an orifice at or near a center point.

3. The dial of claim 2 further including a fastener that extends through said orifices.

4. The dial of claim 1 wherein said second body member having a notch or cutout portion.

5. The dial of claim 4 wherein said second body member notch defined by a substantially arcuate inner edge bounded by linear edges.

6. The dial of claim 1 wherein said body members having substantially circular and planar shapes.

7. The dial of claim 3 wherein said fastener having a first diameter on at least one end and a second diameter between ends, said second diameter is less than said first diameter.

8. The dial of claim 3 wherein said body members may be rotated relative to one another.

9. The dial of claim 1 wherein said second body member having predetermined markings on a surface thereof.

10. The dial of claim 9 wherein said predetermined markings having fuel mixture ratios.

11. The dial of claim 1 wherein said third body member having predetermined markings on a surface thereof.

12. The dial of claim 11 wherein said predetermined markings having fuel mixture ratios.

13. The dial of claim 12 wherein said third-body member having a second set of predetermined markings on a surface.

14. The dial of claim 13 wherein said second set of predetermined markings having fuel information.

15. The dial of claim 1 wherein said first body member having a loop extending from a periphery thereof.

16. A fuel mixture dial system for use on a fuel container, said system including:
a first body member having a cutout portion;
a second body member having a cutout portion;
a third body member, said second body member arranged between said first body member and said third body member, said body members are capable of rotation with respect to one another; and
a fastener that extends through said first, second and third body members.

17. The system of claim 16 wherein said first body member having a loop;
extending from a periphery, said loop having a fastening device engaged therewith and engaged with the fuel container.

18. The system of claim 16 wherein said fastener is a spout of the fuel container.

19. The system of claim 16 wherein said fastener is integrated in a surface of the fuel container.

20. The system of claim 16 wherein at least one of said body members having predetermined markings thereon.
